(19) United States
(12) Patent Application Publication
(10) Pub. No.: US 2018/0261221 A1
(43) Pub. Date: Sep. 13, 2018

(54) SYSTEM AND METHOD FOR CONTROLLING PHYSICAL OBJECTS PLACED ON AN INTERACTIVE BOARD WITH VOICE COMMANDS

(71) Applicants: Zheng Shi, Beijing (CN); Yeliao Tao, Beijing (CN); Huihui Wang, Beijing (CN)

(72) Inventors: Zheng Shi, Beijing (CN); Yeliao Tao, Beijing (CN); Huihui Wang, Beijing (CN)

(21) Appl. No.: 15/976,858

(22) Filed: May 10, 2018

Related U.S. Application Data
(63) Continuation-in-part of application No. PCT/CN2016/105504, filed on Nov. 11, 2016.

(30) Foreign Application Priority Data
Nov. 18, 2015 (CN) 2015107999143

(51) Int. Cl. G10L 15/22; G06F 3/16

(52) U.S. Cl. CPC G10L 15/22; H01Q 21/00; G10L 2015/223; G06F 3/167

(57) ABSTRACT

The present invention provides a system and the accompanying method for controlling physical objects placed on an interactive board with voice commands. The system includes multiple physical objects, each embedded with an identifier and a wireless communication module, an interactive board that is configured to recognize the identifier and location information of a physical object placed on the interactive board, a processor operatively connected to the interactive board, a memory unit operatively connected to the processor and configured to store the correlation relationship between identifiers of physical objects and names of physical objects, a wireless communication module operatively connected to the processor, and a voice input module operatively connected to the processor and configured to receives a voice command from a user. Once multiple physical objects are placed on the interactive board, the processor is configured to generate a command instruction for each of the physical objects, based on the voice command from the user and the identifier and location information of the physical objects.

### CROSS-REFERENCE TO RELATED APPLICATION

This application is a continuation in part of International Patent Application No. PCT/CN2016/105504, entitled “System and Method for Controlling Physical Objects Placed on an Interactive Board with Voice Commands”, filed on Nov. 11, 2016, which claims priority of Patent Application CN2015107999143, entitled “System for Controlling Physical Objects Placed on an Interactive Board with Voice Commands”, filed on Nov. 18, 2015. The entire disclosure of the above application is incorporated herein by reference.

### TECHNICAL FIELD

The present invention relates to the field of physical objects on interactive boards, particularly a system for controlling physical objects placed on an interactive board with voice commands.

### BACKGROUND

Computer systems use a combination of screens and input devices such as keyboards and mice in order for a user to operate computer programs. The GUI (Graphical User Interface) that uses the WIMP (window, icon, menu and pointing device) principle was invented at the Xerox Park Lab in the 1970s. This was to become the template by which all commercial computer systems would adhere to. Indeed, all commercial systems developed by Apple, Microsoft and Sun Microsystems to this day use some form of GUI system in order to allow users to naturally interact with computer programs.

However, sometimes using a voice control system in smart terminals can enhance the user experiences. In order to enhance the user experience of interacting with computer programs by operating physical objects, it is desirable to provide a system for controlling physical objects placed on an interactive board with voice commands.

### SUMMARY OF THE INVENTION

Aiming to solve the problems above, the present invention provides a system and the accompanying method for controlling physical objects placed on an interactive board with voice commands.

In accordance with one embodiment of the present invention, the system includes multiple physical objects, each embedded with an identifier and a wireless communication module, an interactive board that is configured to recognize the identifier and location information of a physical object placed on the interactive board, a processor operatively connected to the interactive board, a memory unit operatively connected to the processor and configured to store the correlation relationship between identifiers of physical objects and names of physical objects, a wireless communication module operatively connected to the processor, and a voice input module operatively connected to the processor and configured to receives a voice command from a user. Once multiple physical objects are placed on the interactive board, the processor is configured to generate a command instruction for each of the physical objects, based on the voice command from the user and the identifier and location information of the physical objects.

In accordance with one embodiment of the present invention, the interactive board further includes a sensor array that contains an array of electrode and an array of RF antenna.

In accordance with one embodiment of the present invention, the physical object is embedded with a movement module. The processor is configured to derive, from the voice command of the user, names of the physical objects and a movement instruction associated with the named physical objects, to retrieve the identifier information of the named physical objects from the memory unit and the location information of the named physical objects, and to generate a command instruction for each of the named physical objects, based on the movement instruction and the identifier and location information of the physical objects placed on the interactive board. The command instruction defines the path of movement of each named physical object.

In accordance with one embodiment of the present invention, the physical object is embedded with a display module. The processor is configured to derive, from the voice command of the user, a display instruction associated with the physical objects, to determine the quantity of the physical objects needed to display a content based on the display instruction, and to generate a command instruction for each of the physical objects, based on the quantity of the physical objects needed to display the content and the identifier and location information of the physical objects needed to display the content. The command instruction defines the content to be displayed by each of the physical object.

The system and the accompanying method disclosed in the present invention would facilitate the manipulation of physical objects by users and enhance the user experiences.

### BRIEF DESCRIPTION OF THE DRAWINGS

To better illustrate the technical features of the embodiments of the present invention, various embodiments of the present invention will be briefly described in conjunction with the accompanying drawings. It should be obvious that the drawings are only for exemplary embodiments of the present invention, and that a person of ordinary skill in the art may derive additional drawings without deviating from the principles of the present invention.

FIG. 1 is a schematic diagram illustrating the process flow of the system for controlling physical objects placed on an interactive board with voice commands in accordance with one embodiment of the invention.

FIG. 2 is an exemplary schematic diagram of the system for controlling robots with voice commands in accordance with one embodiment of the invention.

FIG. 3 is an exemplary schematic diagram of the system for controlling cards with voice commands in accordance with one embodiment of the invention.

### DETAILED DESCRIPTION OF THE INVENTION

The technical scheme in the embodiments of the present invention will be described clearly and completely by reference to the accompanying drawings.

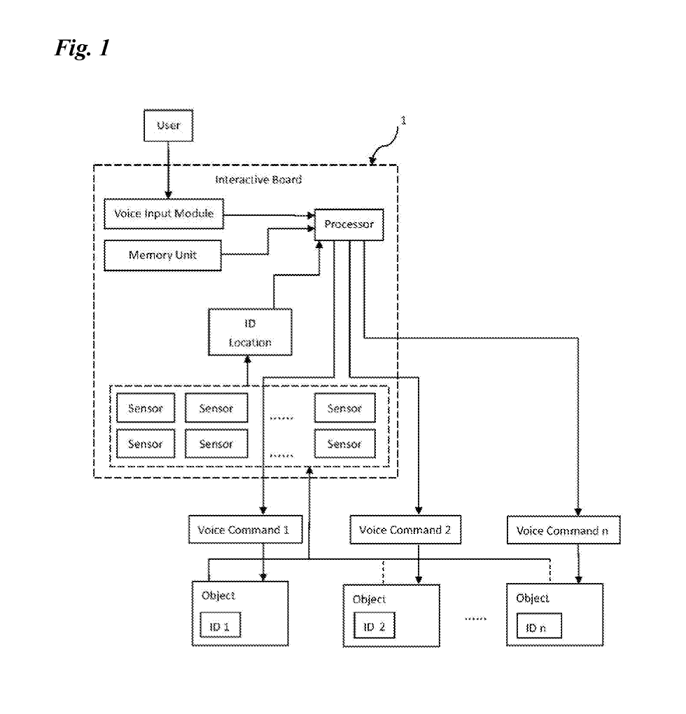

FIG. 1 is schematic diagram illustrating the process flow of the system for controlling physical objects placed on an interactive board with voice commands in accordance with one embodiment of the invention. The system includes multiple physical objects and the interactive board 1. Each physical object is embedded with an identifier and a wireless communication module. The interactive board further includes a processor, a memory unit, a wireless communication module, and a voice input module. The memory unit is operatively connected to the processor and stores the correlation relationship between identifiers of physical objects and names of physical objects. The voice input module might be a microphone, a recorder, or any electronic device that has the function of voice input.

The interactive board 101 is used to recognize the identifier and location information of any physical objects placed on the interactive board 1. The interactive system 1 further includes a sensor array that contains an array of electrode and an array of RF antenna. The array of electrode has at least one electrode, and the array of RF antenna has at least one RF antenna. In this embodiment, the electrode is a chip made of metal such as iron or copper. The physical objects are made of materials that can be capacitively coupled with the electrode. The identifier embedded in the object contains the unique ID of the object. The interactive board 1 derives the position of an object relative to the interactive board, based on the magnitude of the capacitive coupling between of interactive board 1 with the object, and detects the unique ID of the object through the wireless communication between the RF chip (embedded in the wireless communication module) of the object and the RF antenna of the interactive board 1.

The process flow of the system for controlling physical objects placed on the interactive board 1 with voice commands provided in the present invention is as follows:

Step 1: placing multiple physical objects on the interactive board 1, and each physical object is embedded with an identifier and a wireless communication module;

Step 2: recognizing, by the interactive board 1, the identifier and location information of the physical objects placed on the interactive board 1;

Step 3: receiving, by the voice input module, a voice command from a user;

Step 4: generating, by the processor, a command instruction for each physical object placed on the interactive board 1, based on the voice command from the user and the identifier and location information of the physical objects. And the processor transmits the command instructions to the physical objects wirelessly.

Therefore, the system and the accompanying method disclosed in the present invention would facilitate the manipulation of physical objects by users and enhance the user experiences.

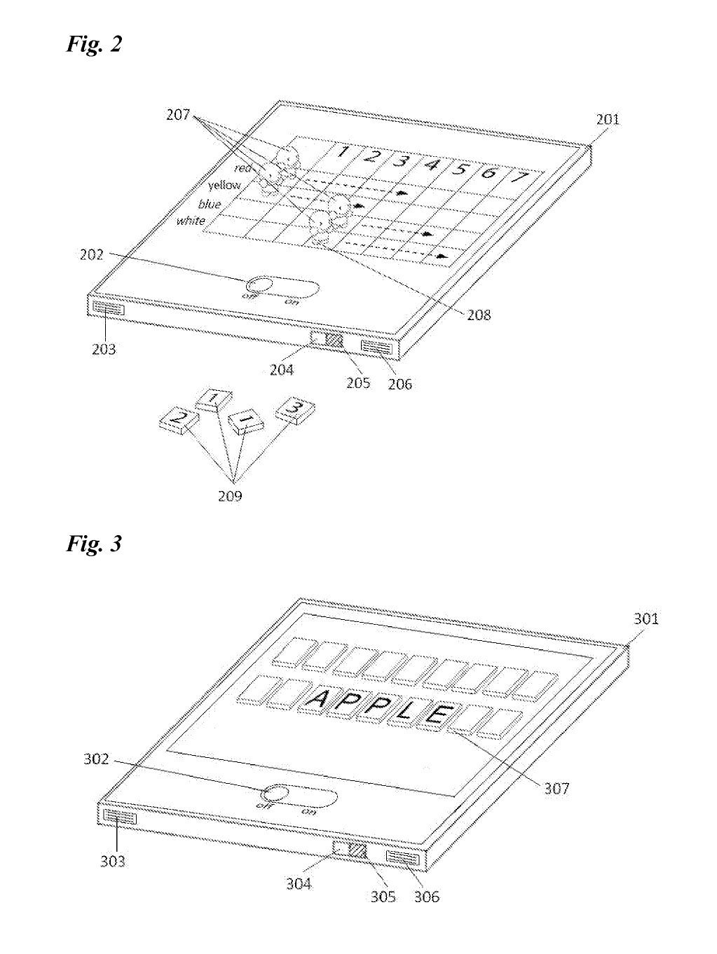

FIG. 2 is an exemplary schematic diagram of the system for controlling robots with voice commands in accordance with one embodiment of the invention. As shown in FIG. 2, each robot 207 is equipped with a movement module 208. With the voice controlling system shown in this figure, two users can play a racing game with each user controlling two robots 207. One a user randomly picks up a card 209 printed with a figure, which determines how many steps a robot 207 can move along the path. In this turn-based game, whoever has both robots under his/her control finish the race first will be the winner.

The robots 207 in red, yellow, blue, and white are placed on the interactive board 201, at the starting positions of the first, the second, the third, and the fourth rows respectively. Then the interactive board 201 recognizes the identifier and location information of these robots 207. Blue and white robots 207 are controlled by user A, and red and yellow ones are controlled by user B. Once the status of the button 202 is switched from “off” to “on”, the voice control function of the system is activated, and the voice input module 203 may receive a voice command from user A such as “the blue robot forwards by three steps, and the white robot forwards by three steps”. The processor 204 derives the names of the robots and a movement instruction associated with each of the named robots (i.e., the blue robot and the white robot) from this voice command of user A, and retrieves the identifier information of the named robots from the memory unit and the location information of the named robots 207 on the interactive board 201, and then generates a command instruction, based on the movement instruction and the identifier and location information of the robots 207 on the interactive board 201, to control each of the named robots 207.

The interactive board 201 further includes a wireless communication module 206 that is operatively connected to the processor 204. And each robot 207 has a wireless communication module by which the processor 204 transmits the command instruction to the robots 207 wirelessly. The path of movement of each named robot 207 is defined by the command instruction.

FIG. 3 is an exemplary schematic diagram of the system for controlling cards with voice commands in accordance with one embodiment of the invention. As shown in FIG. 2, each robot 307 is equipped with a display module. With the voice controlling system shown in this figure, users can play a language learning game with cards.

Once multiple cards 307 are placed in the functioning area of the interactive board 301, the interactive board 301 recognizes the identifier and location information of these cards 307. Once the status of the button 302 is switched from “off” to “on”, the voice control function of the system is activated, and the voice input module 303 may receive a voice command from the user such as “display ‘apple’”. The processor 304 derives, from the voice command of the user, a display instruction associated with the cards 307, determines that five cards 307 are needed to display the word “apple” based on the display instruction, and generates a command instruction, based on the quantity of cards 307 needed to display the word “apple” and the identifier and location information of the cards 307 to be used to display the word, to control each of the five cards 307 placed on the interactive board 301.

The interactive board 301 further includes a wireless communication module 306 that is operatively connected to the processor 304. And each card 307 has a wireless communication module by which the processor 304 transmits the command instruction to the cards 307 wirelessly. The content to be displayed by each card 307 is defined by the command instruction. Specifically, each of the five adjacent cards 307 in the second row displays “A”, “P”, “P”, “L”, “E” respectively.

1. A system for controlling physical objects placed on an interactive board with user voice commands, comprising:
a plurality of physical objects, each embedded with an identifier and a wireless communication module;
an interactive board, configured to recognize the identifier and location information of a physical object placed on the interactive board;
a processor operatively connected to the interactive board;
a memory unit operatively connected to the processor and configured to store the correlation relationship between identifiers of physical objects and names of physical objects;
a wireless communication module operatively connected to the processor;
a voice input module operatively connected to the processor and configured to receives a voice command from a user;
wherein, upon a plurality of physical objects having been placed on the interactive board, the processor is configured to generate a command instruction for each of the plurality of physical objects, based on the voice command from the user and the identifier and location information of the physical objects.

2. The system of claim 1, wherein the interactive board further comprises a sensor array, and wherein the sensor array comprises an array of electrode and an array of RF antenna.

3. The system of claim 1, wherein the physical object is embedded with a movement module.

4. The system of claim 3, wherein the processor is further configured
to derive, from the voice command of the user, names of the physical objects and a movement instruction associated with the named physical objects;
to retrieve the identifier information of the named physical objects from the memory unit and the location information of the named physical objects; and
to generate a command instruction for each of the named physical objects, based on the movement instruction and the identifier and location information of the physical objects placed on the interactive board.

5. The system of claim 4, wherein the command instruction defines the path of movement of each of the named physical object.

6. The system of claim 1, wherein the physical object is embedded with a display module.

7. The system of claim 6, wherein the processor is further configured
to derive, from the voice command of the user, a display instruction associated with the physical objects;
to determine the quantity of the physical objects needed to display a content based on the display instruction; and
to generate a command instruction for each of the physical objects, based on the quantity of the physical objects needed to display the content and the identifier and location information of the physical objects needed to display the content.

8. The system of claim 7, wherein the command instruction defines the content to be displayed by each of the physical object.

9. A method for controlling physical objects placed on an interactive board with user voice commands, comprising:
placing a plurality of physical objects upon an interactive board, with each physical object embedded with an identifier and a wireless communication module;
recognizing, by the interactive board, the identifier and location information of the physical objects placed on the interactive board;
receiving, by a voice input module, a voice command from a user; and
generating, by a processor that is operatively connected to the interactive board, a command instruction for each of the plurality of physical objects, based on the voice command from the user and the identifier and location information of the physical objects, wherein the correlation relationship between identifiers of physical objects and names of physical objects is stored in a memory unit, and wherein the voice input module and the memory unit are operatively connected to the processor.

10. The method of claim 9, wherein the interactive board further comprises a sensor array, and wherein the sensor array comprises an array of electrode and an array of RF antenna.

11. The method of claim 9, wherein the physical object is embedded with a movement module.

12. The method of claim 11, further comprising:
deriving, by the processor, from the voice command of the user, names of the physical objects and a movement instruction associated with the named physical objects;
retrieving, by the processor, the identifier information of the named physical objects from the memory unit and the location information of the named physical objects; and
generating, by the processor, a command instruction for each of the named physical objects, based on the movement instruction and the identifier and location information of the physical objects placed on the interactive board.

13. The method of claim 12, wherein the command instruction defines the path of movement of each of the named physical object.

14. The interactive method of claim 9, wherein the physical object is embedded with a display module.

15. The interactive method of claim 14, further comprising:
deriving, by the processor, from the voice command of the user, a display instruction associated with the physical objects;
determining, by the processor, the quantity of the physical objects needed to display a content based on the display instruction; and
generating, by the processor, a command instruction for each of the physical objects, based on the quantity of the physical objects needed to display the content and the identifier and location information of the physical objects needed to display the content.

16. The interactive method of claim 15, wherein the command instruction defines the content to be displayed by each of the physical object.
